(19) United States
(12) Patent Application Publication
(10) Pub. No.: US 2010/0293300 A1
(43) Pub. Date: Nov. 18, 2010

(54) COMMUNICATION APPARATUS, CONTROL METHOD OF COMMUNICATION APPARATUS, AND PROGRAM

(75) Inventor: Hideaki Tachibana, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/776,999

(22) Filed: May 10, 2010

(30) Foreign Application Priority Data
May 15, 2009 (JP) 2009-118972

(51) Int. Cl. G06F 15/16

(52) U.S. Cl. 709/249

(57) ABSTRACT

A communication apparatus includes a participating device, an identification device, and a notification device. The participating device is capable of participating in a first network and a second network. The identification device is configured to identify a security state of the first network. When the security state identified by the identification device is a predetermined state, the notification device notifies, to the second network, information related to the first network or information related to an apparatus connecting to the first network. When the security state identified by the identification device is not the predetermined state, the notification device does not notify, to the second network, information related to the first network or information related to an apparatus connecting to the first network.

### BACKGROUND OF THE INVENTION

1. Field of the Invention

The present invention relates to a technique by which an apparatus participating in a plurality of networks notifies information of the networks.

2. Description of the Related Art

In recent years, an apparatus can utilize various kinds of services by using a function of the other apparatus existing in a network. In the universal plug and play (UPnP), an apparatus can notify providable service information to the other apparatus, and utilize a service coming from the other apparatus.

A management apparatus which can manage a plurality of networks can be used. Such a management apparatus notifies information in a network to the other network. Information in a network includes information relating to an apparatus connecting to the network, and information of a service which can be utilized when a user connects to the network.

For example, Japanese Patent Application Laid-Open No. 2007-174536 discusses a control terminal. The control terminal, after connecting to a first network, acquires and manages providable service information that a group of apparatuses existing in the first network can provide. Then, the control terminal notifies the acquired service information according to a request of an apparatus existing in a second network.

However, the conventional management apparatus notifies service information for which a user can efficiently utilize networks. Thus, the management apparatus also notifies service information which a user does not want to notify, so that the management apparatus has a security problem.

For example, when the management apparatus connects to a network having a low security level and putting a great value on serviceability, the management apparatus can improve the serviceability by notifying service information according to a request. However, when the management apparatus connects to a network putting a great value on a security rather than serviceability, the management apparatus could cause information leakage by carelessly notifying service information. Therefore, the conventional management apparatus does not flexibly notify information in a network. Further, when the management apparatus does not actually connect to a network, the management apparatus cannot acquire apparatus information and utilizable service information in the network.

### SUMMARY OF THE INVENTION

The present invention is directed to a technique by which an apparatus participating in a plurality of networks can flexibly notify network information and apparatus information.

According to an aspect of the present invention, a communication apparatus includes a participating device, an identification device, and a notification device. The participating device is capable of participating in a first network and a second network. The identification device is configured to identify a security state of the first network. When the security state identified by the identification device is a predetermined state, the notification device notifies, to the second network, information related to the first network or information related to an apparatus connecting to the first network. When the security state identified by the identification device is not the predetermined state, the notification device does not notify, to the second network, information related to the first network or information related to an apparatus connecting to the first network.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and establish a part of the specification, illustrate exemplary embodiments, features, and aspects of the invention and, together with the description, serve to explain the principles of the invention.

FIGS. 1A and 1B illustrate a configuration example of a communication apparatus according to an exemplary embodiment of the present invention.

FIG. 2 illustrates a configuration of a system according to a first exemplary embodiment of the present invention.

FIG. 3 is a flowchart of an operation of a personal computer (PC) according to the first exemplary embodiment.

FIG. 4 illustrates a configuration of a system according to a second exemplary embodiment of the present invention.

FIG. 5 is a flowchart of an operation of a PC according to the second exemplary embodiment.

FIG. 6 illustrates a sequence according to the second exemplary embodiment.

### DESCRIPTION OF THE EMBODIMENTS

Various exemplary embodiments, features, and aspects of the invention will be described in detail below with reference to the drawings.

A wireless communication apparatus according to an exemplary embodiment of the present invention will be described below.

In the following exemplary embodiment, an example, in which a wireless local area network (LAN) system according to the Institute of Electrical and Electronic Engineers 802.11 (IEEE 802.11) series is used, is described. However, a communication system is not restricted in the wireless LAN according to IEEE 802.11. Further, in the exemplary embodiment, automatic setting processing of a communication parameter between an access point (a base station) and a station (a terminal station) is described using Wi-Fi Protected Setup (hereinafter referred to as WPS) as an example. However, another protocol of the setting communication parameter can be used.

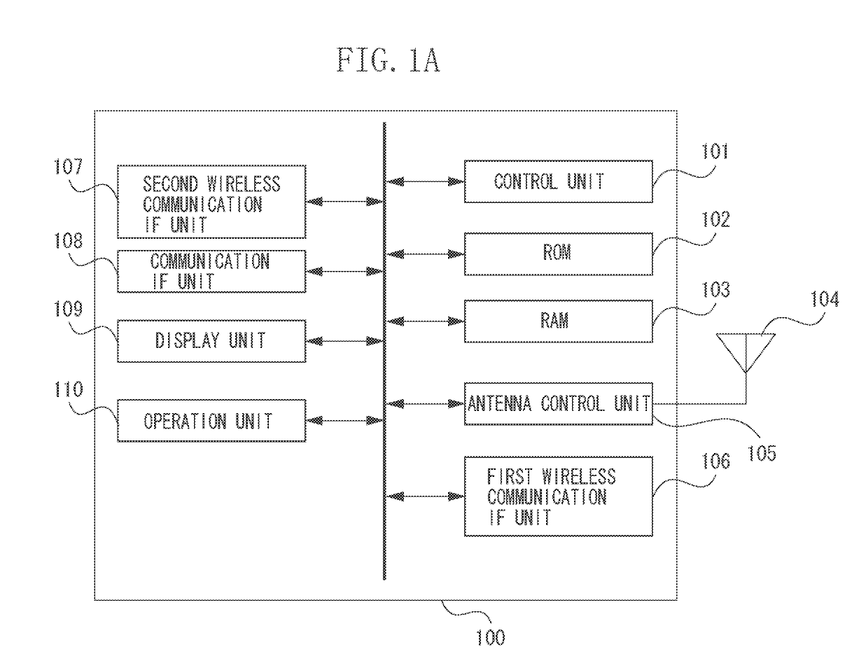

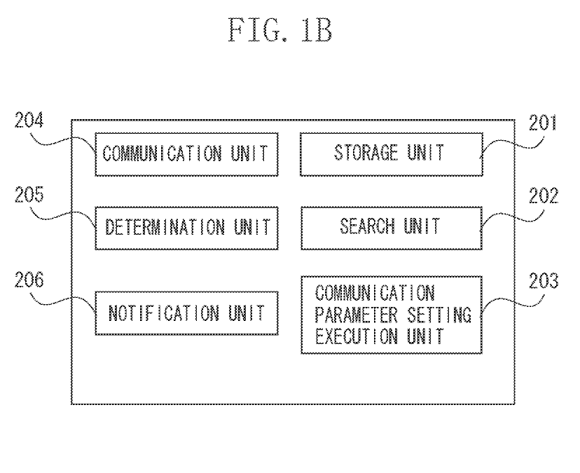

FIGS. 1A and 1B are block diagrams of a communication apparatus which functions as a management apparatus. FIG. 1A is a block diagram of a configuration example of hardware. FIG. 1B is a block diagram of a configuration example of a software module.

In FIG. 1A, the communication apparatus includes a personal computer (hereinafter referred to as PC) 100, a control unit 101 configured to control the PC 100, a read only memory (ROM) 102 configured to store a control command, that is, a program, a random access memory (RAM) 103, an antenna 104, and an antenna control unit 105.

The communication apparatus further includes a first wireless communication interface (hereinafter referred to as wireless communication IF) unit 106, and a second wireless communication IF unit 107. The first wireless communication IF unit 106 performs wireless communication processing, such as establishing and connecting a wireless network. The second wireless communication IF unit 107 performs wireless communication processing, such as establishing and connecting a wireless network, which is different from the first wireless communication IF unit 106.

In the present exemplary embodiment, the first and second wireless communication IF units 106 and 107 perform communication using a wireless LAN system according to IEEE 802.11 series, but the other wireless communication system can be used. The first wireless communication IF unit 106 and the second wireless communication IF unit 107 can be configured to be a physically one interface but logically two interfaces. The communication apparatus further includes a communication IF unit 108 which is not wireless, e.g., a universal serial bus (USB) or IEEE 1394, and includes a display unit 109 and an operation unit 110.

The ROM 102 stores each module in FIG. 1B, and the control unit 100 executes the modules. Apart or the entirety of these modules can be integrated into hardware.

A storage unit 201 stores and manages various kinds of data, such as a parameter required for connecting a wireless network, and apparatus information or service information in the network. A search unit 202 searches the apparatus information or service information in the network. A communication parameter setting execution unit 203 executes the WPS, which is communication parameter automatic setting processing, between a management apparatus and a communication partner.

The communication parameter setting execution unit 203 executes the WPS, and performs providing processing configured to provide the communication parameter to the other communication apparatus. The communication parameters to be provided are parameters necessary for performing wireless communication, e.g., a service set identifier (SSID) which is a network identifier, an encryption system, an encryption key, an authentication system, and an authentication key.

A communication unit 204 controls the wireless communication IF units 106 and 107, and performs wireless data communication. A determination unit 205 performs determination processing for determining whether to notify the apparatus information and service information in the network to the other network managed by the management apparatus. A notification unit 206 notifies the apparatus information and service information in the network to the other network which the management apparatus manages.

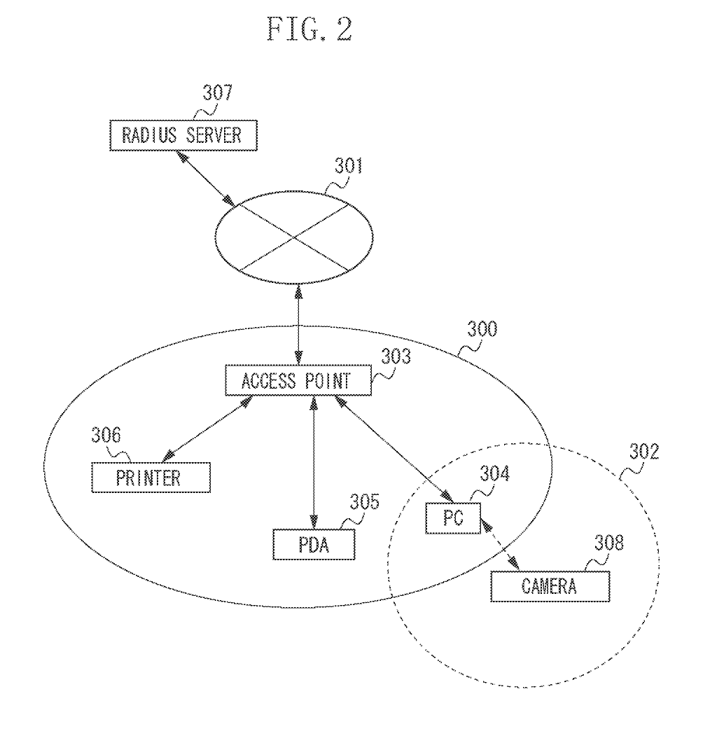

FIG. 2 illustrates a network configuration according to the first exemplary embodiment. The management apparatus described in FIGS. 1A and 1B is a PC 304.

In FIG. 2, an access point 303 establishes a wireless LAN network 300. In the access point 303, the PC 304 functioning as the management apparatus, a personal digital assistant (PDA) 305, and a printer 306 are connected by wireless communication. Further, the access point 303 connects to a network 301. The network 301 is a public line network such as the Internet.

The devices connecting to the access point 303 can receive an internet service via the access point 303. In the present exemplary embodiment, the network 301 is a public line network such as the Internet. However, the network 301 can be another local area network (LAN).

The access point 303 connects to a remote authentication dial in user service (RADIUS) server 307 via the network 301. The RADIUS server 307 is an authentication server configured to perform authentication by the IEEE 802.1X system. The network 300 established by the access point 303 is a network which utilizes a user authentication service by the IEEE 802.1X provided from the RADIUS server 307 and is user authenticated by the IEEE 802.1X system. The user authentication is authentication performing to block communication from a client who is not authenticated (excepting an authentication request), and to permit communication for only a user who is authenticated. Therefore, a device, which is permitted by the user authentication of IEEE 802.1X provided from the RADIUS server 307, can wirelessly connect to the access point 303, and perform wireless communication based on control by the access point 303.

A camera 308 has a communication parameter automatic setting function utilizing the wireless LAN communication function and the WPS. A network 302 is a wireless LAN network established by the PC 304. The PC 304 connects to the access point 303 as a station, and further establishes the network 302 by itself. That is, the PC 304 participates in two networks, i.e., the network 300 and the network 302. The PC 304 can establish the network 302 as an ad hoc network, or can function as an access point and establish the network 302 as an infrastructure network.

In the present exemplary embodiment, the PC 304 functions as a station to the access point 303, and functions as an access point to the camera 308. Further, in the present exemplary embodiment, the access point 303 and the RADIUS server 307 are described as having different configurations, but the access point 303 can internally include the RADIUS server 307.

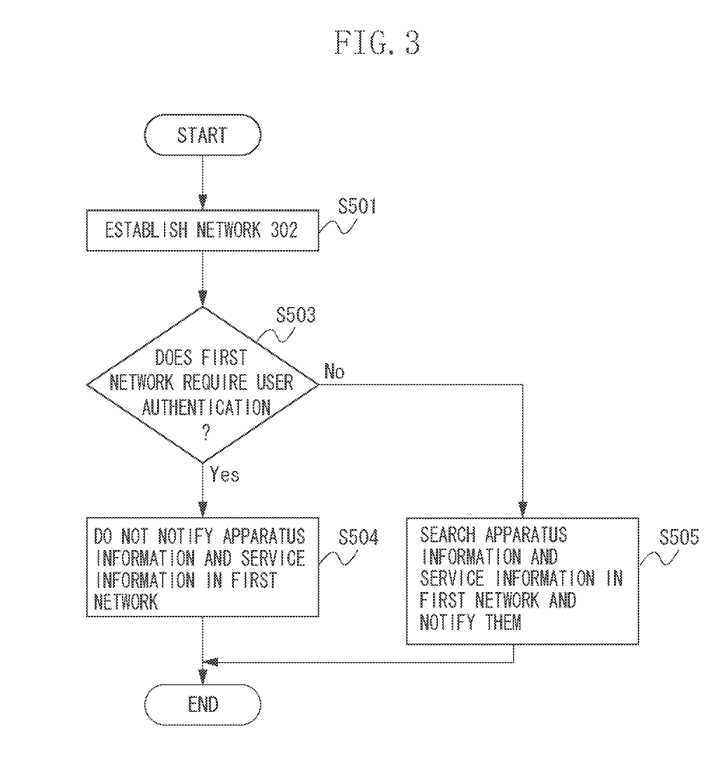

An operation of the PC 304 at the time of connecting the camera 308 to the network 302 will be described with reference to FIG. 3. In addition, in order to connect the camera 308 to the PC 304, it is necessary to set a communication parameter in the camera 308.

The WPS defines communication procedures for setting a communication parameter, which is required for connecting the station to the access point, in the station with an easy operation. In one method of the communication procedures, when a user operates a predetermined button of the access point and a predetermined button of the station, the communication parameter, which is for connecting to the access point, is automatically provided from the access point to the station. In the present exemplary embodiment, this method will be described as an example. However, any other methods defined by the WPS (e.g., a method requiring a password input) or any other methods proposed by various corporations can be used.

In order to connect the camera 308 to the PC 304, a user operates a predetermined button for instructing a start of the communication parameter automatic setting procedure of the WPS between the camera 308 and the PC 304. The predetermined button of the PC 304 is a button provided at an operation unit 110, and is different from a button for starting the communication parameter automatic setting procedure between the PC 304 and the access point 303.

In step S501, when the communication unit 204 of the PC 304 detects that a user operates the predetermined button, the communication unit 204 establishes a second network (the network 302) using the second wireless communication IF unit 107, and starts the WPS. At this time, the communication unit 204 of the PC 304 has already participated in the first network (the network 300) as a station using the first wireless communication IF unit 106.

In step S503, the determination unit 205 in the PC 304 confirms security of the first network (network 300) connecting to the PC 304. The determination unit 205 confirms whether the first network has performed user authentication to an apparatus connecting to the first network. If information of an apparatus and service information, which has received user authentication and is connected to the first network, are notified externally, security may be decreased. Therefore, the determination unit 205 performs this confirmation processing.

In the present exemplary embodiment, the RADIUS server 307 has performed user authentication to the first network by IEEE 802.1X, which is a high security level. Thus, the processing proceeds to step S504. In step S504, when the first network requires the user authentication by the RADIUS server 307, the determination unit 205 of the PC 304 determines not to notify the apparatus information and the service information in the first network to an apparatus in the second network.

In step S505, when the first network does not require the user authentication by the RADIUS server 307, the determination unit 205 of the PC 304 determines to notify the apparatus information and the service information in the first network to the apparatus in the second network.

When the determination unit 205 determines to notify the apparatus information and the service information in the first network to the apparatus in the second network, the search unit 202 of the PC 304 searches the apparatus information and the service information in the first network, and stores the searched results in the storage unit 201.

Then, the notification unit 206 of the PC 304 attaches the apparatus information and the service information in the first network, which are stored in the storage unit 201, to a beacon signal or a probe response signal to notify the apparatus information and the service information. The probe response signal is a response signal responsive to a probe request signal transmitted when the search unit 202 searches the apparatus that is executing the WPS.

When the camera 308 detects a user operation of the predetermined button, the camera 308 starts the WPS, and transmits the probe request signal for searching an access point starting the WPS. The notification unit 206 of the PC 304 receiving the probe request signal transmits the probe response signal including the apparatus information and the service information in the first network. The notification unit 206 performs control to attach the apparatus information and the service information in the first network to the probe response signal.

The camera 308 receiving the response signal can receive the apparatus information and the service information in the first network connected with the PC 304, and notify the information to a user. Then, the communication parameter setting execution unit 203 of the PC 304 and the camera 308 execute a procedure of the WPS, and the PC 304 provides, to the camera 308, a communication parameter for performing communication of the second network connected with the PC 304.

The camera 308 sets the communication parameter received from the PC 304, and connects to the PC 304. In addition, the apparatus information and the service information in the first network can be notified by data communication to the apparatus connecting to the PC 304, or can be notified by the other signal having a field to which the apparatus information and the service information can be attached. Further, the information includes, for example, a device type and a service type.

In the example in FIG. 2, since the first network (the network 300) is a network requiring authentication by the RADIUS server 307, the management apparatus does not notify the apparatus information and the service information in the first network to the apparatus in the second network (the network 302). Therefore, the management apparatus can reduce a decrease of the security level, which may occur by notifying the information related to a network having a high security level to an external network.

In the example in FIG. 2, the security level is determined by confirming whether the user authentication (IEEE 802.1X) is required. However, a case that the security level of the first network is equal to the security level of the second network, or a case that the security level of the second network is higher than the security level of the first network, can be considered. In these cases, the apparatus information and the service information in the second network can be notified.

According to the present exemplary embodiment, the management apparatus notifies the information (apparatus information and service information) related to the first network to the apparatus in the second network, according to the security level of the first network connected with the management apparatus. As a result, the management apparatus can flexibly notify information according to the security level of the first network, and can notify the information while considering serviceability and security.

Further, the management apparatus can reduce a decrease of the security level, which may occur by notifying information related to the first network having a high security level to an apparatus in the other network. Further, when the first network has a low security level, the management apparatus notifies information of the first network to the second network. Thus, serviceability can be improved. Furthermore, an apparatus connecting to a network established by the management apparatus can acquire, before connecting to the network, information related to the network connected with the management apparatus.

In a second exemplary embodiment of the present invention, a method for notifying apparatus information and service information according to a policy managed by a policy server will be described. The policy server collectively manages conditions for notifying apparatus information and service information in a first network.

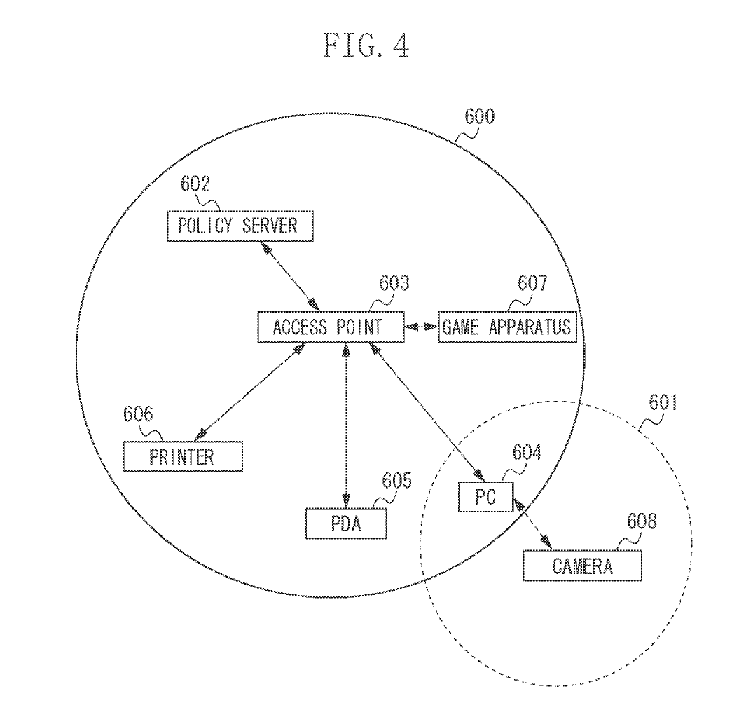

In FIG. 4, an access point 603 establishes a wireless LAN network 600. To the access point 603, a PC 604, a PDA 605, a printer 606, and a game apparatus 607 connect by a wireless LAN function. The PC 604 is a management apparatus described in FIGS. 1A and 1B.

The access point 603 connects to a policy server 602. The policy server 602 manages policies of security information of apparatuses (the access point 603, the PDA 605, the printer 606, and the game apparatus 607) existing in a network 600. The policy of security information indicates a condition for notifying own apparatus information to an external (hereinafter referred to as a notification permission level).

The notification permission level includes a level whether unconditional permission for notification of own apparatus is indicated to an external apparatus, and a level whether permission for notification of own apparatus information is indicated to an apparatus connecting to a network after authentication or user authentication is completed. Further, the notification permission level also includes a level whether permission for notification of own apparatus information is indicated according to a security level of a network connected with an apparatus to which own apparatus information is notified, and a level which does not notify own apparatus information regardless of conditions.

The camera 608 has a wireless LAN communication function and a communication parameter automatic setting function utilizing the WPS. A network 601 is a wireless LAN network established by the PC 604. The network 601 is established having a security level equal to the security level of the network 600.

The PC 604 connects to the access point 603 as a station, establishes the network 601 by itself, and participates in the network 600 and the network 601. The PC 604 can establish the network 601 as an ad hoc network, or can function as an access point and establish as an infrastructure network. In the present exemplary embodiment, the PC 604 functions as a station to the access point 603, and functions as an access point to the camera 608.

The access point 603 has a notification permission level which indicates unconditional permission for notification of own apparatus information to an external apparatus. The printer 606 has the notification permission level which indicates permission for notification of own apparatus information to an apparatus completing apparatus authentication (connecting to the network 601). The game apparatus 607 has the notification permission level which indicates permission for notification of own apparatus information to an apparatus completing apparatus authentication, if the security level of the network 600 is not lower than the security level of the network 601. Further, the notification permission level of the PDA 605 is a level which des not notify in any conditions. Each of the apparatuses can have a plurality of notification permission levels, and the management apparatus can assign a notification permission level not as an apparatus unit but as a group unit or a network unit.

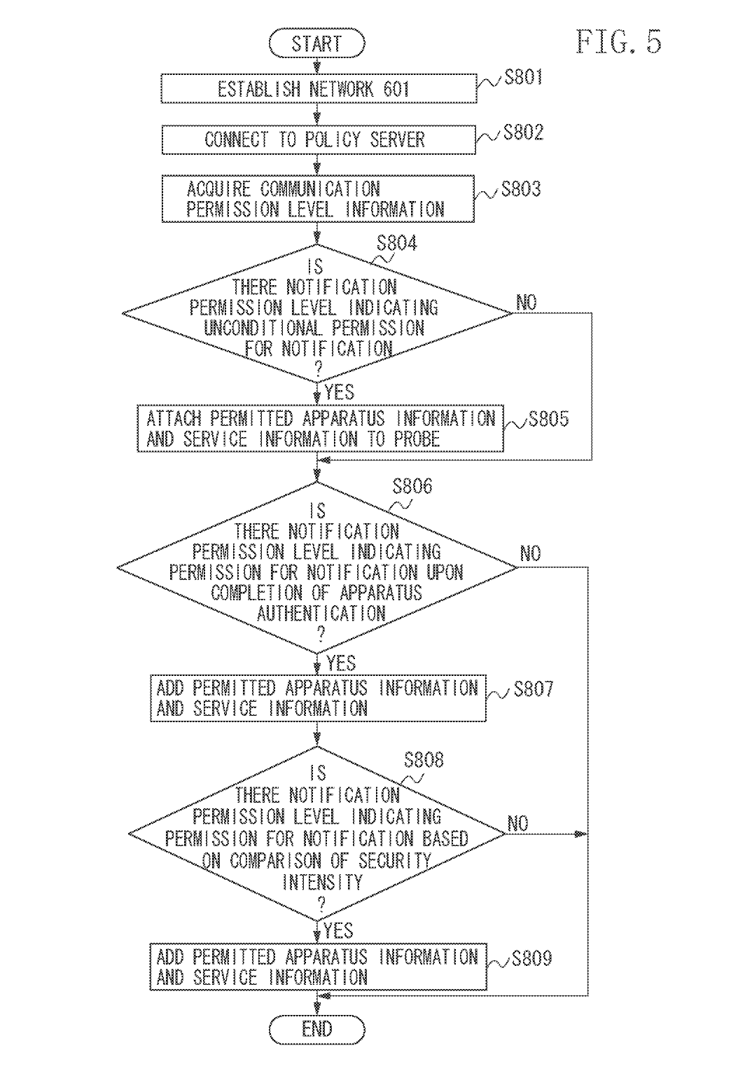

An operation of the PC 604 when the camera 608 connects to the network 601 will be described with reference to FIG. 5.

In order to connect the camera 608 to the PC 304, a user operates a predetermined button to instruct a start of a communication parameter automatic setting procedure of the WPS of the camera 608 and the PC 604. In step S801, when the communication unit 204 of the PC 604 detects that the user operates the predetermined button, the communication unit 204 establishes a second network (the network 302) using the second wireless communication IF unit 107, and starts the WPS. At this time, the communication unit 204 of the PC 604 has already participated in a first network (the network 600) using the first wireless communication IF unit 106.

In step S802, the search unit 202 of the PC 604 connects to the policy server 602. In step S803, the search unit 202 searches communication permission level information of each apparatus set in apparatuses in the network 600, and acquires them. In addition, processing to acquire the communication permission level information of each apparatus can be performed in advance before establishing the network 601.

In step S804, referring to the acquired communication permission level information of each apparatus, the determination unit 205 of the PC 604 determines whether there is a notification permission level indicating unconditional permission for notification. Here, the unconditional permission indicates that the permission for notification of own apparatus information is indicated to entire external apparatuses surrounding the apparatus.

In step S805, when there is a notification permission level indicating unconditional permission for notification, the notification unit 206 of the PC 604 attaches corresponding apparatus information and service information to the probe response signal. The information to be attached includes, for example, a device type and a service type. In addition, a beacon signal other than the probe response signal can be used. When the notification unit 206 of the PC 604 receives the probe request signal, the notification unit 206 transmits the probe response signal as a response to the probe request signal, and thereby notifies apparatus information and service information of the apparatus corresponding to the communication permission level.

In step S806, referring to the communication permission level information of each acquired communication apparatus, the determination unit 205 of the PC 604 determines whether there is a notification permission level indicating permission for notification of own apparatus information when the apparatus authentication (connecting to the second network) is completed.

In step S807, the notification unit 206 of the PC 604 receives the determination from the determination unit 205, and notifies the permitted apparatus information and service information to the apparatus connecting to the second network. At this time, the information to be notified is, for example, encrypted so that only the apparatus connecting to the second network can recognize the information.

The determination unit 205 refers to the communication permission level information of each acquired communication apparatus. Then, in step S808, the determination unit 205 determines whether there is the notification permission level indicating permission for notification of own apparatus information when the apparatus authentication is completed and the security level of the second network (the network 601) is higher than the security level of the first network (the network 600). The determination that the security level of the second network is higher indicates that the security level of the second network is equal to or higher than the security level of the first network.

In step S809, the notification unit 206 of the PC 604 receives the determination from the determination unit 205, and notifies the permitted apparatus information and service information to the apparatus connecting to the second network. At this time, the information to be notified is, for example, encrypted so that only the apparatus connecting to the second network can recognize the information.

In the present exemplary embodiment, the PC 604 notifies the apparatus information and the service information according to the conditions which the policy server 602 collectively manages, and secures security. Further, before connecting to the second network, the PC 604 can recognize the apparatus information of the first network which has a notification permission level indicating permission for notification of own apparatus information to the surrounding external apparatuses.

When the camera 608 detects that a user operates the predetermined button, the camera 608 starts the WPS, and transmits the probe request signal for searching the access point of the operating WPS. The notification unit 206 of the PC 604 receiving the probe request signal transmits the probe response signal to which the apparatus information and the service information are added in step S805. In the present exemplary embodiment, since the access point 603 has the communication permission level indicating unconditional permission for notification of own apparatus information to an external, the PC 604 attaches the information of the access point 603 to the probe response.

The camera 608 receiving the response can notify, to the user, the apparatus information and the service information, which are received from the PC 604. The communication parameter setting execution unit 203 of the PC 604 and the camera 608 execute the procedure of the WPS, and the PC 604 provides, to the camera 608, the communication parameter for communicating with the second network connecting to the PC 604.

The camera 608 sets the received communication parameter, and connects to the PC 604. The notification unit 206 of the PC 604 notifies, to the camera 608 connecting to the network 601, the apparatus information in the network 600 which satisfies the conditions.

In the present exemplary embodiment, the printer 606 has the notification permission level indicating permission for notification of own apparatus information upon completion of apparatus authentication (after connecting to the network 601). Thus, the PC 604 notifies the information of the printer 606 to the camera 608. Further, since the network 600 and the network 601 have an equal security level, the PC 604 also notifies the information of the game apparatus 607. Since the PDA 605 has the communication permission level indicating no permission for notification in any environments, the PC 604 does not notify the information of the PDA 605.

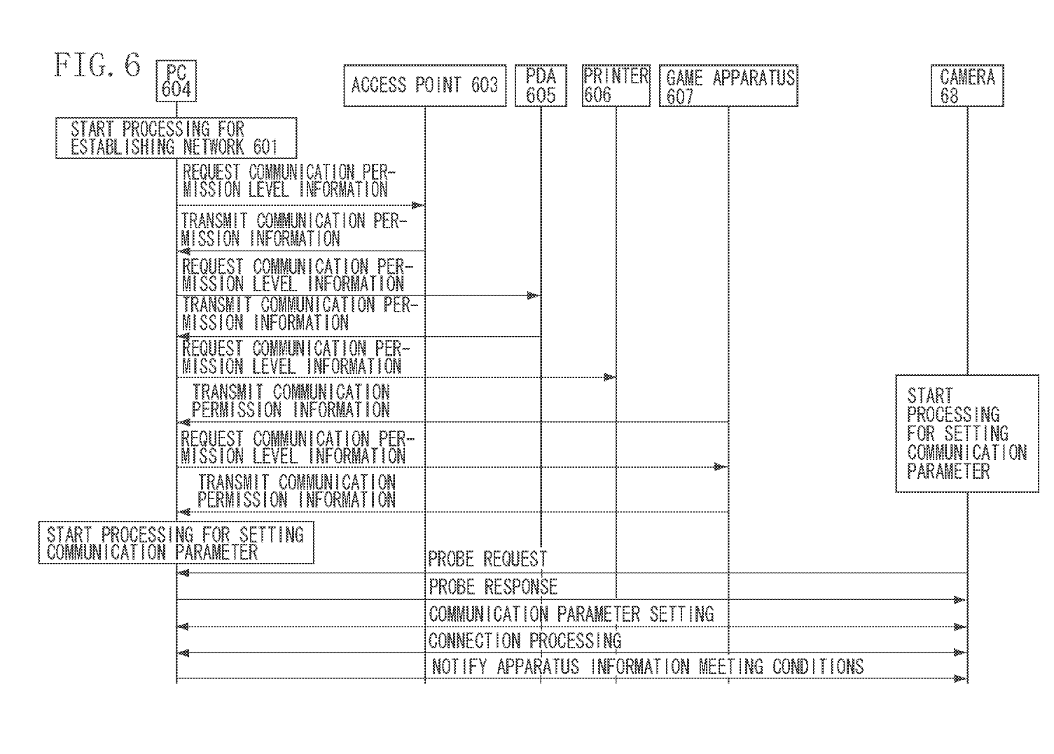

In the second exemplary embodiment, the PC 604 acquires a communication permission level of each apparatus from the policy server 602. However, the PC 604 can directly acquire the communication permission level information from each apparatus, as illustrated in FIG. 6. In FIG. 6, the PC 604 requests the communication permission level information to each apparatus, each apparatus transmits the communication permission level information, and the PC 604 directly acquires the information from the apparatus. The PC 604 can request the information to each of the apparatuses by utilizing UPnP.

When the processing in FIG. 3 according to the first exemplary embodiment is performed and the determination unit 205 determines to notify the apparatus information and the service information in the first network to the apparatus in the second network in step S505, the second exemplary embodiment can be executed. That is, when the first network requires authentication, the information is not notified to the second network. On the other hand, when the first network does not require authentication, the information is notified according to the notification permission level of each apparatus. Thereby, notification can be controlled more carefully.

According to the present exemplary embodiment, the management apparatus notifies, to the apparatus in the second network, the information (apparatus information and service information) related to the first network, according to the security level of the apparatus in the first network connected with the management apparatus. As a result, information can be notified according to the security level of the apparatus in the first network considering serviceability and security.

Further, the management apparatus can reduce a decrease of the security level, which may occur by notifying the information of an apparatus having a high security level to an apparatus in the other network. Further, an apparatus connecting to the network established by the management apparatus can acquire information related to the network connected with the management apparatus, before connecting to the network. Furthermore, even if there is some information not permitted to acquire before connection, the apparatus can acquire the information after connecting to the network if the information is permitted.

According to the exemplary embodiments of the present invention, an apparatus participating in a plurality of networks can flexibly notify network information and apparatus information, and can thus reduce a decrease of the security level.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-118972 filed May 15, 2009, which is hereby incorporated by reference herein in its entirety.

What is claimed is:

1. A communication apparatus comprising:
a participating device capable of participating in a first network and a second network;
an identification device configured to identify a security state of the first network; and
a notification device configured to notify, to the second network, information related to the first network or information related to an apparatus connecting to the first network when the security state identified by the identification device is a predetermined state, and configured not to notify, to the second network, information related to the first network or information related to an apparatus connecting to the first network when the security state identified by the identification device is not the predetermined state.

2. The communication apparatus according to claim 1, wherein the identification device is configured to identify whether the first network is a network performing authentication by an authentication server.

3. The communication apparatus according to claim 1, wherein the second network is a network established by the communication apparatus.

4. The communication apparatus according to claim 1, wherein the first network is a network established by another apparatus.

5. A communication apparatus comprising:
a participating device capable of participating in a first network and a second network;
an identification device configured to identify security information of an apparatus connecting to the first network;
a determination device configured to determine whether to notify information related to the first network or information related to the apparatus connecting to the first network to the second network according to the security information identified by the identification device; and
a notification device configured to notify, to the second network, the information related to the first network or the information related to the apparatus connecting to the first network according to a determination by the determination device.

6. The communication apparatus according to claim 5, wherein the identification device is configured to identify notification permission level information indicating whether permission for notification of the information related to the apparatus connecting to the first network is indicated.

7. The communication apparatus according to claim 6, wherein the notification permission level information includes one of information indicating whether unconditional permission for notification of apparatus information is indicated to an apparatus in the second network, information indicating whether permission for notification of apparatus information is indicated to an apparatus connecting to a network after apparatus authentication or user authentication is completed, information indicating whether permission for notification of apparatus information is indicated according to a security level of a network connecting to an apparatus having the apparatus information, and information indicating that apparatus information is not to be notified regardless of conditions.

8. The communication apparatus according to claim 5, wherein the second network is a network established by the communication apparatus.

9. The communication apparatus according to claim 5, wherein the first network is a network established by another apparatus.

10. A control method in a communication apparatus capable of participating in a first network and a second network, the method comprising:
identifying a security state of the first network; and
notifying, to the second network, information related to the first network or information related to an apparatus connecting to the first network when the identified security state is a predetermined state; and
not notifying, to the second network, information related to the first network or information related to an apparatus connecting to the first network when the identified security state is not the predetermined state.

11. A control method in a communication apparatus capable of participating in a first network and a second network, the method comprising:
identifying security information of an apparatus connecting to the first network;
determining whether to notify information related to the first network or information related to the apparatus connecting to the first network to the second network according to the identified security information; and
notifying, to the second network, the information related to the first network and the information related to the apparatus connecting to the first network according to the determination.
